(19) United States
(12) Patent Application Publication
(10) Pub. No.: US 2017/0015441 A1
(43) Pub. Date: Jan. 19, 2017

(54) CONTROL DEVICE FOR ROCKET

(71) Applicant: IHI Corporation, Koto-ku (JP)

(72) Inventor: Takenori OTSUKA, Tokyo (JP)

(73) Assignee: IHI Corporation, Koto-ku (JP)

(21) Appl. No.: 15/277,081

(22) Filed: Sep. 27, 2016

Related U.S. Application Data
(63) Continuation of application No. PCT/JP2015/064508, filed on May 20, 2015.

(30) Foreign Application Priority Data
May 28, 2014 (JP) 2014-110219

(51) Int. Cl. B64G 1/24; B64G 1/64; B64G 1/40

(52) U.S. Cl. CPC B64G 1/242; B64G 1/40; B64G 1/645

(57) ABSTRACT

The flight path of a two-staged rocket (1) is periodically calculated during flight, and the estimated impact point when a first-stage rocket body (11) or a fairing (15) is separated and discarded is periodically calculated from a second-stage rocket (13) at each passing scheduled point in the predicted flight path. As long as there is a passing scheduled point such that the estimated impact points of the first-stage rocket (11) and the fairing (15) are both within the safe area, a process is periodically performed to designate the passing scheduled point safe and nearest to ILL of the two-staged rocket (1) as the separate-and-discard point of the first-stage rocket body (11), and when the two-staged rocket (1) reaches this separate-and-discard point, the first-stage rocket body (11) or the fairing (15) is separated and discarded.

### CROSS REFERENCE TO RELATED APPLICATIONS

This application is a continuation application of international application No. PCT/JP2015/064508 filed May 20, 2015, which claims priority to Japanese Patent Application No. 2014-110219 filed May 28, 2014, each of which is hereby incorporated by reference in their entity.

### BACKGROUND

1. Technical Field

The present disclosure relates to a control device for a rocket.

2. Description of Related Art

For example, in a multi-staged rocket for use in launching a payload such as a satellite, an engine of an n-th-stage rocket is ignited following a cut-off of an (n−1)-th-stage rocket engine, and an (n−1)-th-stage rocket body is separated and discarded from an n-th-stage rocket.

The (n−1)-th-stage rocket body, which is separated and discarded, may be dropped to impact within a safe area apart from the inhabited lands on the earth. Accordingly, in an event of launching the multi-staged rocket, engines of a second-stage rocket and after may be ignited at appropriate timing, that is, to separate and discard a preceding rocket body at appropriate timing.

As a technology related to this, there is a proposal for separating and discarding a discarded object from a flying object when a horizontal flying distance from a takeoff point of the flying object, which is calculated from an acceleration of the flying object, exceeds a distance of a known separation/discarding point from the takeoff point, the separation/discarding point being suitable for dropping the discarded body to such a safe area (for example, Patent Document 1).

### RELATED ART DOCUMENT

Patent Document 1: JP H06-344994 A

### SUMMARY

Incidentally, in consideration of differences in mass properties, engine performances and weather conditions and the like at a launching time, the fuel of a little more than a standard quantity by adding a margin thereto may be loaded on a rocket. Therefore, when the rocket is separated and discarded at such a predetermined point as in the conventional proposal, the rocket body is separated and discarded in a state where fuel by the excess amount remains therein at most times.

The rocket may load the fuel, of which amount is appropriate in response to a consumption of the fuel by the rocket engine, in terms of enhancing a launch capability of the rocket by extending the acceleration with respect to a loaded amount of the fuel. In other words, it is ideal that the fuel loaded in the rocket be consumed as completely as possible. From a viewpoint, in terms of enhancing the launch capability of the rocket, the rocket body may not be separated or discarded at such a predetermined point as in the conventional proposal.

Moreover, also in a single-staged rocket in which the n-th rocket is not separated and discarded, the rocket engine may be cut-off after the loaded fuel is consumed and the rocket body may be dropped to impact within a safe area in order to enhance the launch capability of the rocket.

The present disclosure has been made in consideration of the above-described circumstances. It is an object of the present disclosure to provide a control device for a rocket, which can drop a discarded object, such as used rocket body of which engine is already cut-off, to impact within the safe area on the earth while enhancing the launch capability by consuming the loaded fuel as much as possible.

In order to achieve the above-described object, a control device for a rocket according to the present disclosure, which is described in claim 1, is a control device for a rocket, cutting-off a rocket engine during flight of the rocket and dropping a discarded object, the control device being characterized by including: a flight path calculating processor that periodically calculates a predicted flight path, the rocket therealong flies from now on by residual fuel, based on a flight schedule (speed, position and attitude) of the rocket; an impact point calculating processor that periodically calculates estimated impact points of the discarded object in a case of cutting-off the rocket engine at respective scheduled passing points on the predicted flight path of the rocket; and an engine cut-off controller that cuts-off the rocket engine and drops the discarded object in a case where the flight position of the rocket coincides with a scheduled passing point nearest to the impact limit line (ILL), the scheduled passing point also being where the discarded object dropped at a scheduled passing point is expected to impact within a safe area on predetermined topographic data, the scheduled passing point being among respective scheduled passing points on a predicted flight path calculated in a past cycle.

Moreover, in order to achieve the above-described object, a control device for a rocket according to the present disclosure, which is described in claim 2, is a control device for a rocket, cutting-off a rocket engine during flight of the rocket and dropping a discarded object, the control device being characterized by including: a flight path calculating processor that periodically calculates a predicted flight path, the rocket flies therealong from now on by residual fuel, based on a flight schedule (speed, position and attitude) of the rocket; an impact point calculating processor that periodically calculates estimated impact points of the discarded object in a case of cutting-off the rocket engine at respective scheduled passing points on the predicted flight path of the rocket; and an engine cut-off controller, in a case where it is estimated that none of estimated impact points of the discarded object, calculated for respective scheduled passing points on a predicted flight path calculated in a next cycle from a change of at least one of the predicted flight path of the rocket and the estimated impact point of the discarded object between two immediately previous cycles continuing with each other, comes to be located within a safe area on predetermined topographic data, for cutting-off the rocket engine and dropping the discarded object at a scheduled passing point nearest to ILL, the scheduled passing point being where an estimated impact point of the discarded object is located within the safe area on the topographic data, the scheduled passing point being among respective scheduled passing points on a predicted flight path calculated at a present time, and the estimated impact point being calculated to correspond to each of the scheduled passing points.

In accordance with the control device for a rocket according to the present disclosure, which is described in claim 1, the path (predicted flight path) the rocket is predicted to fly therealong by the residual fuel during the flight of the launched rocket is predicted. This predicted flight path is periodically calculated and updated to latest contents. Then, every time when the predicted flight path is calculated, the respective points (estimated impact points) on which the discarded object is estimated to impact in the case where the rocket engine is cut-off at a plurality of the respective scheduled passing points set on the predicted flight path are calculated. The estimated impact points are also periodically calculated and updated to latest contents.

Then, the rocket engine is cut-off and the discarded object is dropped when the flying rocket reaches the scheduled passing point nearest to ILL, the scheduled passing point also being where the discarded object dropped at the scheduled passing point is estimated to impact within the safe area on the predetermined topographic data, the scheduled passing point being among the respective scheduled passing points on the predicted flight path of the rocket, which was calculated in the past cycle.

Moreover, also in the control device for a rocket according to the present disclosure, which is described in claim 2, in a similar way to the control device for a rocket, which is described in claim 1, the predicted flight path of the rocket and the estimated impact points of the discarded object in the case where the rocket engine is cut-off at the plurality of respective scheduled passing points set on the predicted flight path are periodically calculated during the flight of the launched rocket, and are updated to the latest contents.

Then, if the discarded object does not impact within the safe area of the topographic data when the rocket engine is cut-off and the discarded object is dropped at the respective passing points on the predicted flight path, which are calculated in the next cycle, then the rocket engine is cut-off and the discarded object is dropped when the flying rocket reaches the scheduled passing point nearest to ILL, the scheduled passing point also being where it is predicted that then engine is cut-off and the discarded object dropped at the scheduled passing point impacts within the safe area on the predetermined topographic data, the scheduled passing point being among the respective scheduled passing points on the latest predicted flight path of the rocket, which is calculated at the present time.

Here, as the discarded object from the rocket, for example, there are mentioned: a fairing separated and discarded in an event of putting a payload in a single-staged rocket or a multi-staged rocket; an (n−1)-th-stage rocket body separated and discarded from an n-th-stage rocket in the multi-staged rocket; and further; the single-staged rocket itself.

Therefore, in accordance with the control device for a rocket according to the present disclosure, which is described in claim 1 or claim 2, for example, even if the fuel consumed by the rocket engine in order to fly the rocket along the determined flight path fluctuates due to conditions of mass properties, engine performances, weather and the like, the rocket is flied to the scheduled passing point nearest to ILL at which the discarded item impacts within the safe area of the topographic data, and thereafter, the rocket engine is cut-off, and the discarded object is dropped.

Hence, while extending the acceleration of the rocket by consuming the loaded fuel as much as possible to thereby enhance the launch capability thereof, the discarded object can be dropped to the safe area.

Moreover, the control device for a rocket according to the present disclosure, which is described in claim 3, is the control device for a rocket according to the present disclosure, which is described in either one of claims 1 and 2, characterized in that the rocket is a multi-staged rocket, the discarded object includes at least an (n−1)-th-stage rocket body separated and dropped from an n-th-stage rocket, the flight path calculating processor periodically calculates a predicted flight path, along which the multi-staged rocket flies from now on by propelling power generated by an (n−1)-th-stage rocket engine by using residual fuel, based on a flight schedule (speed, position and attitude) of the multi-staged rocket, and for respective scheduled passing points on the predicted flight path of the multi-staged rocket, the impact point calculating processor periodically calculates estimated impact points of the (n−1)-th-stage rocket body in a case where the (n−1)-th-stage rocket engine is cut-off and the (n−1)-th-stage rocket is separated and dropped from the n-th-stage rocket.

In accordance with the control device for a rocket according to the present disclosure, which is described in claim 3, in accordance with the control device for rocket according to the present disclosure, which is described in either one of claims 1 and 2, in a case where the rocket is a multi-staged rocket, the separation/discarding of the (n−1)-th-stage rocket body in which the rocket engine is cut-off from the n-th-stage rocket is performed at the scheduled passing point, which is nearest to ILL, and at which the separated and dropped (n−1)-th-stage rocket body impacts within the safe area.

Therefore, the acceleration of the multi-staged rocket by the propelling power of the (n−1)-th-stage rocket engine can be extended by consuming the fuel of the (n−1)-th-stage rocket as much as possible, and the (n−1)-th-stage rocket body separated and dropped from the n-th-stage rocket can impact within the safe area.

In accordance with the present disclosure, the discarded object such as the discarded n-th rocket body and the single-staged rocket of which engine is already cut-off can be dropped to impact within the safe area while enhancing the launch capability by consuming the loaded fuel as much as possible.

### BRIEF DESCRIPTION OF DRAWINGS

FIG. 1 is a partially cutaway front view showing a schematic configuration of a second-stage rocket on which a control device according to a first embodiment of the present disclosure is mounted.

FIG. 2 is an explanatory view showing a nominal flight path of the two-staged rocket of FIG. 1 and a drop trajectory of a separated/discarded object from the rocket.

FIG. 3 is an explanatory view showing topographic data of down ranges (areas on range) including impact limit lines (ILLS) of other countries, which are stored in an internal memory of a controller in FIG. 1.

FIG. 4 is a flowchart showing a procedure of processing performed by a mounted computer in FIG. 1.

FIG. 5 is a flowchart showing an example of a specific procedure of engine cut-off determination processing in FIG. 4.

FIG. 6 is a flowchart showing an example of a specific procedure of engine cut-off determination processing in FIG. 4, which is performed by a mounted computer of a two-staged rocket on which a control device according to a second embodiment of the present disclosure is mounted.

FIG. 7 is a partially cutaway front view showing a schematic configuration of a single-staged rocket on which control devices according to a third embodiment and fourth embodiment of the present disclosure are mounted.

FIG. 8 is an explanatory view showing a nominal flight path of the single-staged rocket in FIG. 7 and a drop trajectory of the rocket body.

FIG. 9 is a flowchart showing a procedure of processing performed by a mounted computer in FIG. 7.

FIG. 10 is a flowchart showing an example of a specific procedure of engine cut-off determination processing in FIG. 9, which is performed by the mounted computer of the single-staged rocket on which the control device according to the third embodiment of the present disclosure is mounted.

FIG. 11 is a flowchart showing an example of a specific procedure of engine cut-off determination processing in FIG. 9, which is performed by the mounted computer of the single-staged rocket on which the control device according to the fourth embodiment of the present disclosure is mounted.

### DETAILED DESCRIPTION OF EMBODIMENTS

A description is made below of embodiments of a control device for a rocket according to the present disclosure while referring to the drawings. In the following embodiments, a description is made of a two-staged rocket as an example of the rocket.

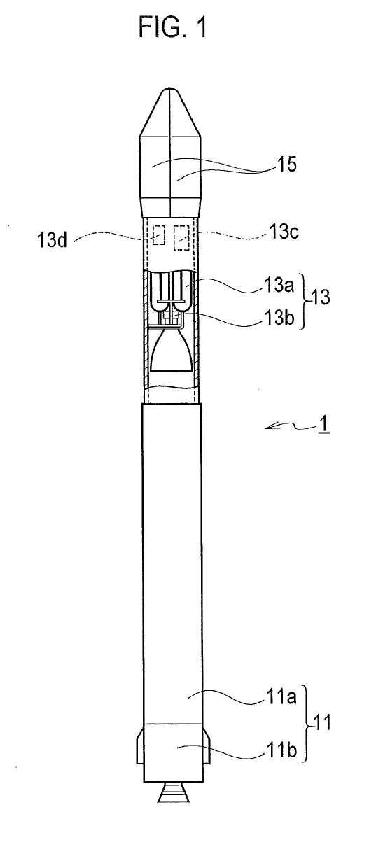

FIG. 1 is a partially cutaway front view showing a schematic configuration of a two-staged rocket on which the control device according to a first embodiment is mounted. A two-staged rocket 1 of this embodiment, which is shown in FIG. 1, includes first-stage and second-stage rockets 11 and 13 and a fairing 15.

The first-stage and second-stage rockets 11 and 13 include fuel tanks 11a and 13a of liquid oxygen and liquid hydrogen, for example, and rocket engines 11b and 13b each uses this set of propellants. Note that illustration of a solid rocket booster or an auxiliary engine, which are for use at a time of launching, in some cases, the two-staged rocket 1, is omitted.

The second-stage rocket 13 is connected to an upper portion of the first-stage rocket 11 through a separation mechanism (not shown). When the first-stage rocket engine 11b is cut-off by substantially finishing use of fuel (liquid oxygen and liquid hydrogen) of the fuel tank 11a, the first-stage rocket body 11 is separated from the second-stage rocket 13 by the separation mechanism, and the second-stage rocket engine 13b is ignited.

The fairing 15 covers a payload (not shown) connected to an upper portion of the second-stage rocket 13 through a separation mechanism, and opens to halves from a tip end thereof during flight of the two-staged rocket 1, and is separated and discarded from the two-staged rocket 13.

In some case, the fairing 15 is separated and discarded from the second-stage rocket 13 before the first-stage rocket body 11 is separated and discarded from the second-stage rocket 13. However, in this embodiment, a description is made of a case where the fairing 15 is separated and discarded from the second-stage rocket 13 after elapse of a certain time since the first-stage rocket 11 is separated and discarded from the second-stage rocket 13 or after the first-stage rocket 11 is propelled by a certain distance since the first-stage rocket 11 is separated and discarded.

When the fairing 15 is separated and discarded from the second-stage rocket 13, the payload (not shown) in an inside of the fairing 15 is exposed. When the second-stage rocket engine 13b is cut-off by achieving the orbital velocity, the payload is separated from the second-stage rocket 13, and is placed into a satellite orbit.

The ignition and cut-off of the first-stage and second-stage rocket engines 11b and 13b and the separation of the first-stage rocket 11 and the fairing 15 from the second-stage rocket 13 are controlled by a mounted computer 13c (corresponding to a control device for a rocket in claims) in the second-stage rocket 13.

To the mounted computer 13c, an IMU (Inertial Measuring Unit) 13d is connected, which calculates a flight speed, flight position and flight attitude of the two-staged rocket 1 by using gyro and acceleration sensors. The mounted computer 13c controls propelling directions and the like of the rocket engines 11b and 13b based on the flight speed, the flight position and the flight attitude, which are calculated by the IMU 13d, so that the two-staged rocket 1 can fly through a nominal flight path of which data is stored in an internal memory of the mounted computer 13c.

Moreover, the mounted computer 13c monitors amounts of the fuel remaining in the fuel tanks 11a and 13a of the two-staged rocket 1, and calculates a flight path of the two-staged rocket 1 based on the monitored amounts of fuel and on the flight speed, flight position and flight attitude of the two-staged rocket 1, which are sensed by the IMU 13d.

The flight path predicted by the mounted computer 13c (that is, a predicted flight path) includes a path along which the two-staged rocket 1 flies from now on by propelling power of the first-stage rocket engine 11b by using residual fuel of the first-stage rocket 11 until the first-stage rocket engine 11b is cut-off. Hereinafter, this predicted flight path is referred to as a first-stage predicted flight path.

Moreover, the predicted flight path includes a path along which the two-staged rocket 1 flies by propelling power of the second-stage rocket engine 13b by using the fuel of the second-stage rocket 13 after the first-stage rocket body 11 is separated and discarded from the second-stage rocket 13. Hereinafter, this predicted flight path is referred to as a second-stage predicted flight path.

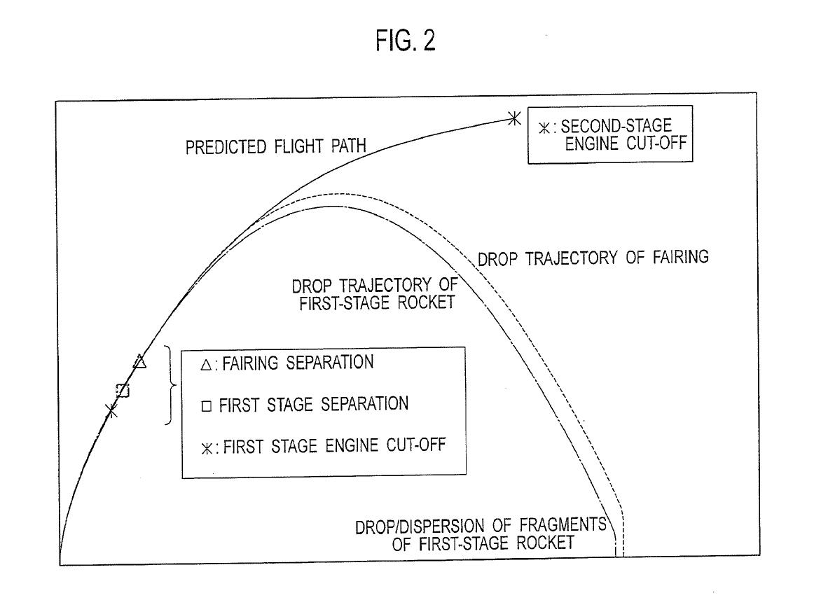

Note that a solid line in an explanatory view in FIG. 2 is the predicted flight path of the two-staged rocket 1, which is calculated by the mounted computer 13e. In this solid line, a segment from a launching point in which both of a ground surface distance and an altitude are “0” to a cut-off point of the first-stage rocket engine 11b, which is indicated by a left plot point between two asterisk plot points present in FIG. 2, is the first-stage predicted flight path. Moreover, a segment from a separating/discarding point of the first-stage rocket engine 11b to a cut-off point of the second-stage rocket engine 13b, which is indicated by a right plot point between the two asterisk plot points present in FIG. 2, is the second-stage predicted flight path.

Furthermore, the mounted computer 13c calculates a point where the first-stage rocket body 11 is estimated to impact, that is, an estimated impact point (IIP: Instantaneous Impact Point) in a case where the first-stage rocket engine 11b is cut-off at the cut-off point on the first-stage predicted flight path, and the first-stage rocket body 11 is separated and discarded from the second-stage rocket 13 at the separating/discarding point placed forward thereof.

Moreover, the mounted computer 13c calculates respective points on which pieces of the fairing 15 are estimated to impact, that is, estimated impact points in a case where the two-staged rocket 1, which passes a certain time or is propelled by a certain distance since the first-stage rocket body 11 is separated and discarded, opens the fairing 15 to halves and separates and discards the fairing 15 from the second-stage rocket 13 at a separating/discarding point indicated by a blank triangle plot point in FIG. 2 on the second-stage predicted flight path.

Note that the mounted computer 13c individually predicts the estimated impact points of the first-stage rocket body 11 and the fairing 15 based on the flight speeds, flight positions and flight attitudes of the two-staged rocket 1 on the respective first-stage and second-stage predicted flight paths.

Moreover, the estimated impact point of the first-stage rocket body 11 is varied depending on to which point on the first-stage predicted flight path the cut-off point of the first-stage rocket engine 11b is to be decided. Accordingly, the mounted computer 13c sets a plurality of scheduled passing points on the first-stage predicted flight path, and individually predicts calculates the estimated impact points of the first-stage rocket body 11 for cases where the respective scheduled passing points are decided to be the cut-off point of the first-stage rocket engine 11b.

Furthermore, the second-stage predicted flight path of the two-staged rocket 1 is varied depending on where the cut-off point of the first-stage rocket engine 11b on the first-stage predicted flight path is to be decided. Accordingly, after deciding the cut-off point of the first-stage rocket engine 11b, the mounted computer 13c calculates the second-stage predicted flight path of the two-staged rocket 1, which corresponds to the decided cut-off point. Then, the mounted computer 13c calculates an estimated impact point of the fairing 15 while taking, as the separating/discarding point, a position of the two-staged rocket 1 on the second-stage predicted flight path when the two-staged rocket 1 flies for a certain time or by a certain distance from the separating/discarding point of the first-stage rocket body 11.

As described above, the separating/discarding point of the fairing 15 on the second-stage predicted flight path is assumed so as to individually correspond to each of the scheduled passing points on the first-stage predicted flight path, which is assumed as the cut-off point of the first-stage rocket engine 11b. Hence, in the same way as the estimated impact point of the first-stage rocket body 11, the mounted computer 13c calculates the estimated impact point, which corresponds to the separating/discarding point of the fairing 15, individually in response to the respective scheduled passing points on the first-stage predicted flight path assumed as the cut-off point of the first-stage rocket engine 11b.

Incidentally, the first-stage through second-stage predicted flight path of the two-staged rocket 1, which is calculated by the mounted computer 13c, is so-called nominal flight path. However, in an actual flight path of the two-stage rocket 1, dispersion with respect to the nominal flight paths occurs by an influence of a dispersion in mass properties, engine performances or weather condition or the like. Then, this dispersion is not reflected on the first-stage and second-stage predicted flight paths of the two-staged rocket 1, which serve as bases in an event where the mounted computer 13c calculates the estimated impact points of the first-stage rocket body 11 and the fairing 15.

Accordingly, in consideration of the dispersion of the actual flight path of the two-staged rocket 1 with respect to the nominal flight path, the mounted computer 13e calculates the estimated impact points of the first-stage rocket body 11 and the fairing 15 as ranges including some error.

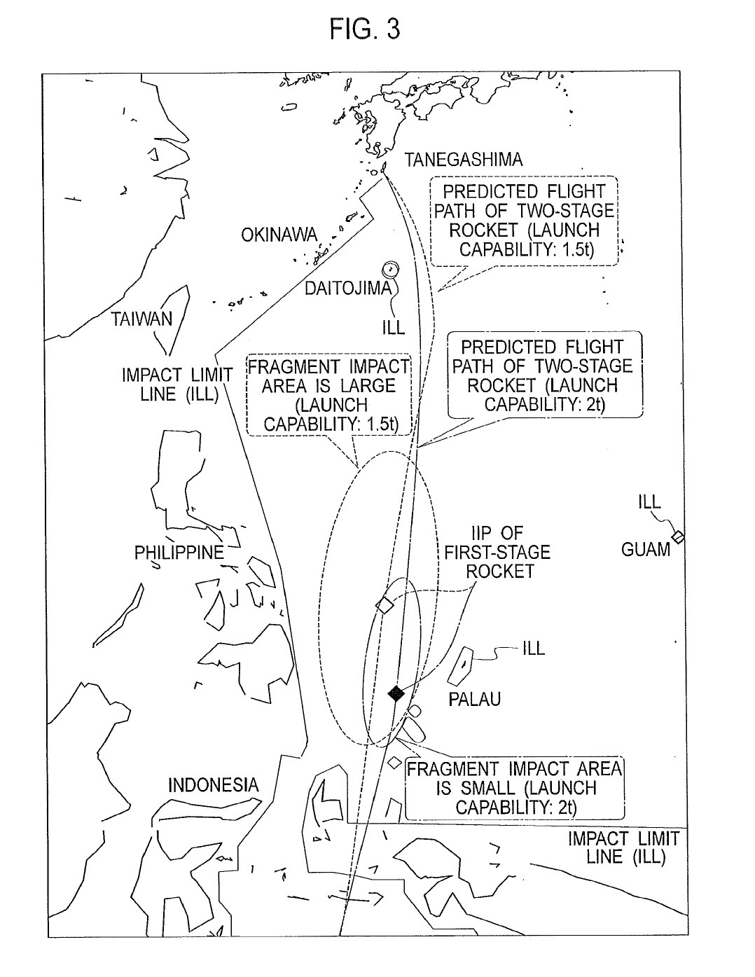

Note that, in the internal memory of the mounted computer 13c, topographic data that defines a safe area where the impact of the discarded object from the two-staged rocket 1 is allowed is stored together with data of the nominal flight path of the two-staged rocket 1. As shown in an explanatory view of FIG. 3, this topographic data is topographic data of down ranges (areas on a range) including impact limit lines (ILL) indicating boundary lines of lands to be protected from the impact of the discarded object and seas adjacent thereto. Hence, a residual area excluding areas on more land sides than the impact limit lines becomes a safe area SA where the impact of the discarded object of the two-staged rocket 1 is allowed.

Moreover, in the internal memory of the mounted computer 13c, data is stored, which indicates an area on which there drop fragments of the first-stage rocket body 11 and the fairing 15 separated and discarded from the second-stage rocket 13. A size and shape of such a fragment drop area differ depending on a launch capability of the two-staged rocket 1, that is, a launching enabled weight of the payload (not shown).

This is because, as the two-staged rocket 1 has a higher launch capability, inertia in a flying direction, which acts on the first-stage rocket body 11 at the separation/discarding time, is larger, and a dispersion degree of the fragments of the first-stage rocket 11 after the separation/discarding, the dispersion being caused by force other than the inertia, is smaller.

For example, a fragment impact area of the first-stage rocket body 11 in a two-staged rocket 1 with a launch capability of 1.5 t (ton), which flies on a predicted flight path shown by a dotted line in FIG. 3, becomes such a range as shown by a dotted oval. Moreover, a fragment impact area of the first-stage rocket 11 in a two-stage rocket 1 with a launch capability of 2 t (ton), which flies on a predicted flight path shown by an alternate long and short dash line in FIG. 3, becomes a smaller range than the fragment impact area of the first-stage rocket body 11 in the two-staged rocket 1 with a launch capability of 1.5 t (ton).

Note that a blank rhombus in FIG. 3, which is plotted on the predicted flight path of the two-staged rocket 1 with a launch capability of 1.5 t (ton), is a estimated impact point (IIP) of the first-stage rocket body 11 in the two-staged rocket 1 with a launch capability of 1.5 t (ton). Moreover, a solid rhombus in FIG. 3, which is plotted on the predicted flight path of the two-staged rocket 1 with a launch capability of 2 t (ton), is a predicted drop estimated impact point (IIP) of the first-stage rocket body 11 in the two-staged rocket 1 with a launch capability of 2 t (ton).

By an amount that the inertia in the flying direction, which acts on the first-stage rocket body 11 at the separation/discarding time, is larger in the two-staged rocket 1 with a launch capability of 2 t (ton) than in the two-staged rocket 1 with a launch capability of 1.5 t (ton), the estimated impact point of the first-stage rocket body 11 in the two-stage rocket 1 with a launch capability of 2 t (ton) is placed closer to the front in the flying direction of the two-staged rocket 1 with respect to the fragment impact area.

Then, the mounted computer 13c collates the estimated impact points of the first-stage rocket body 11 and the fairing 15 (which include the fragment drop area) with the topographic data, and extracts a set in which both of the estimated impact point of the first-stage rocket body 11 and the estimated impact point of the fairing 15 are located within the safe area SA. Moreover, the mounted computer 13c defines a scheduled passing point, which corresponds to the extracted set and is assumed to be the separating/discarding point of the first-stage rocket body 11 on the first-stage predicted flight path, as an official separating/discarding point of the first-stage rocket body 11.

At this time, in a case where there are plural sets of combinations in each of which both of the estimated impact point of the first-stage rocket body 11 and the estimated impact point of the fairing 15, each including the fragment impact area, are located within the safe area SA, the mounted computer 13c defines a scheduled passing point, which is nearest to ILL of the two-staged rocket 1 among a plurality of scheduled passing points corresponding to the combinations, as the cut-off point of the first-stage rocket engine 11b.

In such a way, until the first-stage rocket engine 11b is cut-off, the two-staged rocket 1 will fly much faster by the propelling power of the first-stage rocket engine 11b. Therefore, the launch capability of the two-staged rocket 1 can be enhanced.

Note that the mounted computer 13c periodically and repeatedly calculates the predicted flight path of the two-staged rocket 1 and the estimated impact points of the first-stage rocket body 11 and the fairing 15, the predicted flight path and the estimated impact points being shown in FIG. 2. In such a way, even if a consumption pace of the fuel by the two-staged rocket 1 fluctuates during the flight due to a change of the mass properties, engine performances or weather condition, and the like, the predicted flight path and the estimated impact point, which are calculated by the mounted computer 13c, can be updated in response to such a fluctuation at any time.

Then, when the two-staged rocket 1 reaches the cut-off condition of the first-stage rocket engine 11b (when the flight position of the two-staged rocket 1 coincides therewith), the mounted computer 13c cut-off the first-stage rocket engine 11b, and thereafter, separates the first-stage rocket body 11 from the second-stage rocket 13.

Moreover, when the two-staged rocket 1 that has separated and discarded the first-stage rocket body 11 therefrom reaches the separating/discarding point of the fairing 15 (with which the flight position of the two-staged rocket 1 coincides), the mounted computer 13c separates the fairing 15 from the second-stage rocket 13.

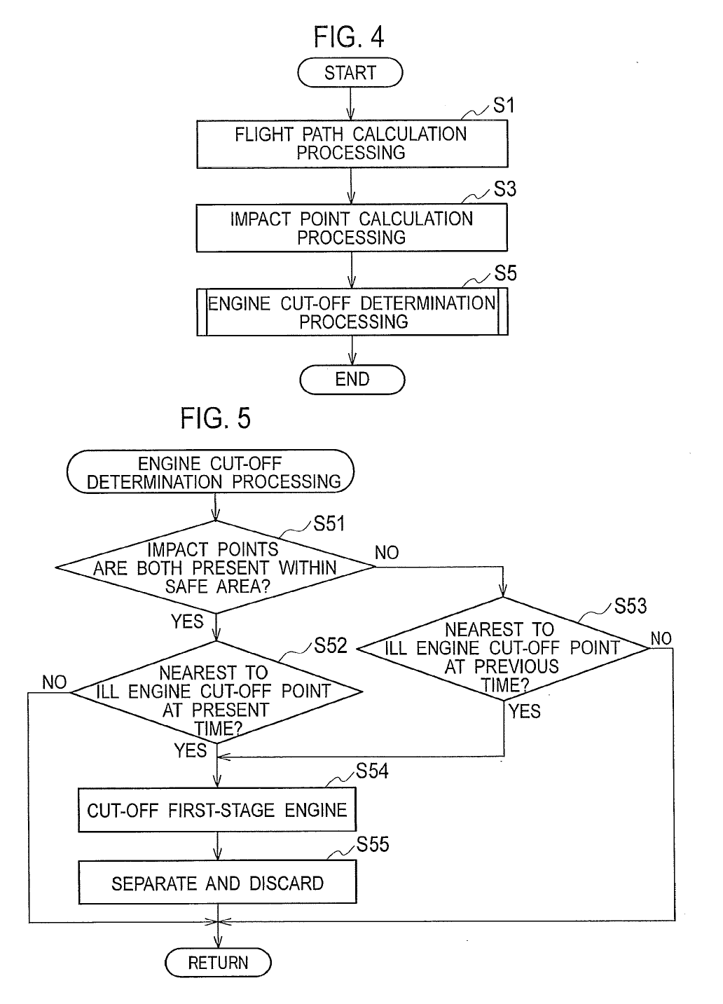

Next, referring to a flowchart of FIG. 4, a description is made of processing regarding the cut-off of the first-stage rocket engine 11b, which is performed by the above-mentioned mounted computer 13c during the flight of the two-staged rocket 1.

In order to cut-off the first-stage rocket engine 11b so that the first-stage rocket body 11 and the fairing 15 can drop to impact within the safe area SA, the mounted computer 13c of this embodiment executes flight path calculation processing (Step S1), impact point estimation processing (Step S3), and engine cut-off determination processing (Step S5), which are shown in FIG. 4, periodically and repeatedly during the flight of the two-staged rocket 1.

Then, in the flight path calculation processing of Step S1, the mounted computer 13c calculates the first-stage predicted flight path of the two-staged rocket 1 before separating and discarding the first-stage rocket body 11 and the second-stage predicted flight path of the two-staged rocket 1 after separating and discarding the first-stage rocket body 11.

Note that the mounted computer 13c calculates the first-stage predicted flight path based on the amount of the fuel remaining in the first-stage fuel tank 11a and based on the flight schedule (speed, position and attitude) before the first-stage rocket engine 11b of the two-staged rocket 1 is cut-off, the flight speed, the flight position and the flight attitude being sensed by the IMU 13d.

Moreover, the mounted computer 13c calculates the second-stage predicted flight path based on the separating/discarding point of the first-stage rocket body 11, based on the amount of the fuel remaining in the second-stage fuel tank 13a, and based on the flight schedule (speed, position and attitude) after the first-stage rocket engine 11b of the two-staged rocket 1 is cut-off, the flight speed, the flight position and the flight attitude being sensed by the IMU 13d.

Next, in the impact point estimation processing of Step S3, the mounted computer 13e estimates the impact points (estimated impact points) of the first-stage rocket body 11 and the fairing 15. Here, the mounted computer 13c estimates the impact points (estimated impact points) of the first-stage rocket body 11 and the fairing 15 based on the cut-off point of the first-stage rocket engine 11b, which is assumed on the predicted flight path of the first-stage rocket 11.

Subsequently, in the engine cut-off determination processing of Step S5, first, as shown in a flowchart of FIG. 5, the mounted computer 13c confirms whether or not there is a set, in which both of the impact points (estimated impact points) of the first-stage rocket body 11 and the fairing 15 are located within the safe area SA, among the sets of the impact points of the first-stage rocket body 11 and the fairing 15, which are estimated in the impact point calculation processing of Step S3 in the present cycle (Step S51).

In a case where there is a set in which both of the impact points of the first-stage rocket body 11 and the fairing 15 are located within the safe area SA (YES in Step S51), the mounted computer 13c determines whether or not the two-staged rocket 1 has reached the engine cut-off condition, which is safe and nearest to ILL of the two-staged rocket 1 among the cut-off points of the first-stage rocket engine 11b, which correspond to the estimated impact points of the first-stage rocket body 11 and the fairing 15, the estimated impact points being calculated in Step S3 of FIG. 4 in the present cycle (Step S52).

Then, in the case of having determined that the two-staged rocket 1 has reached the engine cut-off condition, which is safe and nearest to ILL, of the two-staged rocket 1 (YES in Step S52 or Step S53), then the mounted computer 13c cuts-off the first-stage rocket engine 11b (Step S54), and separates and discards the first-stage rocket body 11 and the fairing 15 from the second-stage rocket 13 at the respective separating/discarding points individually corresponding to the engine cut-off point (Step S55), and ends the separation determination processing.

As obvious also from the above description, in this embodiment, Step S1 in the flowchart of FIG. 4 is processing corresponding to a flight path calculation processor in the claims. Moreover, in this embodiment, Step S3 in FIG. 4 is processing corresponding to an impact point estimation processor in the claims. Furthermore, in this embodiment, Step S5 in FIG. 4 is processing corresponding to an engine cut-off controller in the claims.

As described above, in the two-staged rocket 1 of this embodiment, the flight path of the two-staged rocket 1 is periodically calculated during the flight, and the estimated impact points of the first-stage rocket body 11 and the fairing 15, which are separated and discarded from the second-stage rocket 13, in the case where the first-stage rocket engine 11 is cut-off at each scheduled passing point on the predicted flight path are calculated periodically.

Then, while the scheduled passing points in each of which both of the estimated impact points of the first-stage rocket body 11 and the fairing 15 are located within the safe area SA are present, the processing for defining the scheduled passing point safe and nearest to ILL of the two-staged rocket 1 as the cut-off point of the first-stage rocket engine 11b is periodically performed.

Therefore, the cut-off point of the first-stage rocket engine 11b is updated to the farthest scheduled passing point safe and nearest to ILL of the two-staged rocket 1 at any time. In such a way, the separating/discarding points of the first-stage rocket body 11 and the fairing 15 are also updated to the points safe and nearest to ILL of the two-stage rocket 1 at any time.

Hence, while extending the acceleration by consuming the fuel in the fuel tanks 11a and 13a of the first-stage rocket 11 and the second-stage rocket 13 as much as possible to thereby enhance the launch capability of the two-staged rocket 1, the first-stage rocket body 11 and the fairing 15, which are separated and discarded from the second-stage rocket 13, can be dropped to impact within the safe area SA.

Next, a description is made of a control device according to a second embodiment of the present disclosure, which is mounted on the two-staged rocket 1.

Also in this embodiment, the mounted computer 13c periodically calculates the flight path of the two-staged rocket 1 during the flight, and periodically calculates the estimated impact points in the case where the first-stage rocket body 11 and the fairing 15 are separated and discarded from the second-stage rocket 13 at the respective scheduled passing points on the predicted flight path.

Then, in this embodiment, the mounted computer 13c estimates whether the estimated impact points of the first-stage rocket body 11 and the fairing 15, which are calculated in a next period, comes to be located within the safe area SA of the topographic data. The mounted computer 13c performs this estimation based on a change of at least one of the predicted flight path of the two-staged rocket 1 and the estimated impact points of the first-stage rocket body 11 and the fairing 15, the change being observed between two immediately previous cycles which continue with each other.

Specifically, for example, the mounted computer 13c adds variations obtained from the estimated impact points of the first-stage rocket body 11 and the fairing 15, which are calculated in the previous cycle, to the estimated impact points of the first-stage rocket body 11 and the fairing 15, which are calculated in the present cycle, and thereby calculates the estimated impact points of the first-stage rocket body 11 and the fairing 15, which are predicted in the next cycle.

Then, the mounted computer 13c confirms both of the estimated impact points of the first-stage rocket body 11 and the fairing 15 in the next cycle, the estimated impact points being thus calculated, are placed within the safe area SA.

Alternatively, for example, the mounted computer 13c adds a variation obtained from the cut-off point of the first-stage rocket engine 11b, which is calculated in the previous cycle, to the cut-off point of the first-stage rocket engine 11b, which is calculated in the present cycle, and thereby calculates the cut-off point of the first-stage rocket engine 11b, which is calculated in the next cycle.

Then, from the estimated cut-off point of the first-stage rocket engine 11b in the next cycle, the mounted computer 13c individually calculates the separating/discarding point of the first-stage rocket body 11 and the separating/discarding point of the fairing 15. Moreover, the mounted computer 13c confirms both of the estimated impact point of the first-stage rocket body 11 and the estimated impact point of the fairing 15 in the case where the first-stage rocket body 11 and the fairing 15 are individually separated and discarded from each separating/discarding point are located within the safe area SA.

As both of the estimated impact points of the first-stage rocket body 11 and the fairing 15 are placed within the safe area SA, then there is obtained such an estimation result that the estimated impact points of the first-stage rocket body 11 and the fairing 15, which are calculated in the next cycle, are located within the safe area SA of the topographical data.

Specifically, the mounted computer 13c extracts the sets of the combinations, in each of which both of the estimated impact point of the first-stage rocket body 11 and the estimated impact point of the fairing 15 are placed within the safe area SA, among the sets of the estimated impact points of the first-stage rocket body 11 and the fairing 15, which are calculated in the present cycle. Then, the mounted computer 13c defines the scheduled passing point nearest to ILL of the two-staged rocket 1 among the scheduled passing points corresponding to the extracted sets as the cut-off point of the first-stage rocket engine 11b.

Then, when the two-staged rocket 1 reaches the cut-off point of the first-stage rocket engine 11b (when the flight position of the two-staged rocket 1 coincides therewith), the mounted computer 13e cuts-off the first-stage rocket engine 11b. Then, the mounted computer 13c separates the first-stage rocket body 11 from the second-stage rocket 13 at the separation/discarding point corresponding to the engine cut-off point.

Moreover, when the two-staged rocket 1 that has separated and discarded the first-stage rocket body 11 therefrom reaches the separating/discarding point of the fairing 15 (with which the flight position of the two-staged rocket 1 coincides), the separating/discarding point corresponding to the engine cut-off point, the mounted computer 13c separates the fairing 15 from the second-stage rocket 13.

Therefore, also in this embodiment, in order to separate and discard the first-stage rocket body 11 and the fairing 15 so that the first-stage rocket body 11 and the fairing 15 can drop to impact within the safe area SA, the mounted computer 13c of this embodiment performs the flight path calculation processing (Step S1), the impact point estimation processing (Step S3), and the engine cut-off determination processing (Step S5), which are shown in FIG. 4, periodically and repeatedly during the flight of the two-staged rocket 1.

Then, in the flight path calculation processing of Step S1 and the impact point estimation processing of Step S3, the mounted computer 13c performs similar processing to that of the first embodiment. Meanwhile, in the engine cut-off determination processing of Step S5, the mounted computer 13c performs different processing from that of the first embodiment.

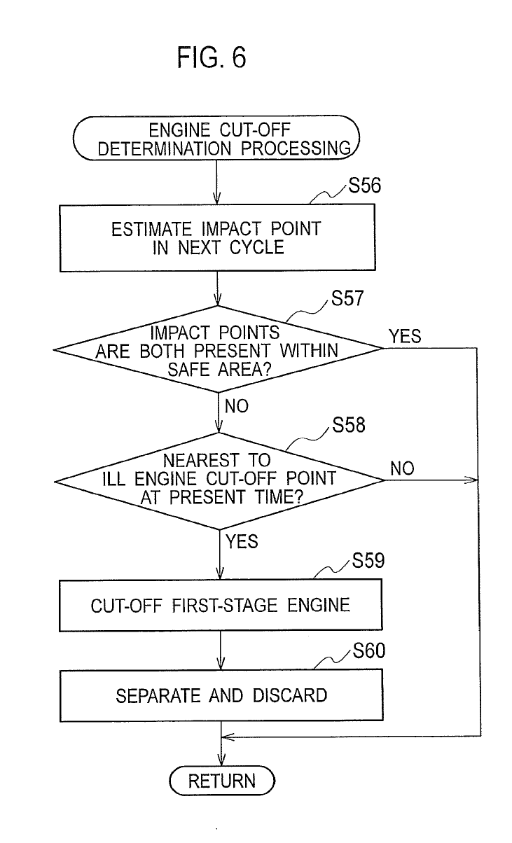

Specifically, first, as shown in a flowchart of FIG. 6, the mounted computer 13c calculates the estimated impact points of the first-stage rocket body 11 and the fairing 15, which are calculated in the next cycle (Step S56), and confirms there is a set in which both of the estimated impact points of the first-stage rocket body 11 and the fairing 15, which are thus calculated, are located within the safe area SA of the topographical data.

In a case where there is a set in which both of the estimated impact points of the first-stage rocket body 11 and the fairing 15, which are thus calculated, are located within the safe area SA of the topographical data (YES in Step S57), the mounted computer 13c ends the engine cut-off determination processing.

Then, in the case of having determined that the two-stage rocket 1 has reached the safe and nearest to ILL point to cut-off engine of the two-staged rocket 1 (YES in Step S58), the mounted computer 13c cuts-off the first-stage rocket engine 11b (Step S59), separates and discards the first-stage rocket body 11 and the fairing 15 from the second-stage rocket 13 at the respective separating/discarding points individually corresponding to the engine cut-off point (Step S60), and ends the engine cut-off determination processing.

Also in the above-mentioned embodiment, Step S1 in the flowchart of FIG. 4 is the processing corresponding to the flight path calculation processor in the claims. Moreover, also in this embodiment, Step S3 in FIG. 4 is the processing corresponding to the impact point estimation processor in the claims. Furthermore, also in this embodiment, Step S5 in FIG. 4 is the processing corresponding to the engine cut-off controller in the claims.

Then, in the two-staged rocket 1 of this embodiment, the flight path of the two-staged rocket 1 is periodically calculated during the flight, and the sets of the estimated impact points of the first-stage rocket body 11 and the fairing 15, which are separated and discarded from the second-stage rocket 13, in the case where the first-stage rocket engine 11b is cut-off at each scheduled passing point on the predicted flight path are calculated periodically.

Moreover, from the changes of the predicted flight path and the estimated impact points between two continuous cycles, the predicted drop estimated impact points of the first-stage rocket body 11 and the fairing 15, which are calculated in the next cycle, are individually estimated.

Then, while the set in which both of the estimated impact points of the first-stage rocket body 11 and the fairing 15, which are thus estimated, are located within the safe area SA is present, the cut-off point of the first-stage rocket engine 11b is not decided, but the processing for calculating the predicted flight path and the estimated impact points is also performed in the next cycle.

Therefore, until the set in which both of the estimated impact points of the first-stage rocket body 11 and the fairing 15, which are thus estimated, are located within the safe area SA comes not to be present, the cut-off point of the first-stage rocket engine 11b is updated to the farthest scheduled passing point which is safe and nearest to ILL of the two-staged rocket 1 at any time. In such a way, the separating/discarding points of the first-stage rocket body 11 and the fairing 15 are also updated to the farthest points which are safe and nearest to ILL the two-staged rocket 1 at any time.

Hence, while extending the acceleration by consuming the fuel in the fuel tanks 11a and 13a of the first-staged rocket 11 and the second-stage rocket 13 as much as possible to thereby enhance the launch capability of the two-staged rocket 1, the first-stage rocket body 11 and the fairing 15, which are separated and discarded from the second-stage rocket 13, can be dropped to impact within the safe area SA.

Note that, in the above-mentioned respective embodiments, the description has been made of the examples where the present disclosure is individually applied to the cases of separating and discarding the first-stage rocket body 11 and the fairing 15 from the second-stage rocket 13. Hence, in these embodiments, the first-stage rocket body 11 and the fairing 15 correspond to a discarded object in the claims.

Moreover, the present disclosure is not limited to the above-mentioned respective embodiments, and is also applicable to an event of separating and discarding the fairing from the rocket no matter whether the rocket may be a single-staged or a multi-staged one, and to a case of separating and discarding an n-th-stage rocket from an (n−1)-th-stage rocket in the multi-staged rocket. In the former case, the fairing corresponds to the discarded object in the claims, and in the latter case, the (n−1)-th-stage rocket corresponds to the discarded object in the claims. As a matter of course, as in the above-mentioned respective embodiments, the present disclosure can also be embodied in a form in which both of the fairing and the (n−1)-th-stage rocket body correspond to the discarded object in the claims.

Moreover, the present disclosure is also applicable to a single-staged rocket that does not include the fairing and drops as a discarded object by the cut-off of the engine. A description is made below of embodiments of such a case of applying the present disclosure to the rocket as described above.

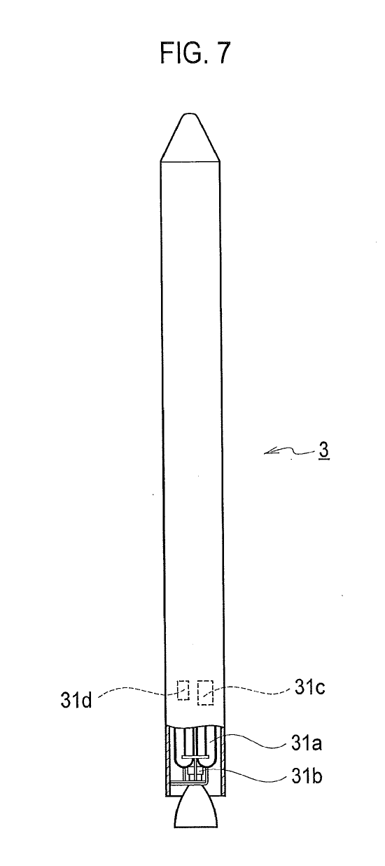

FIG. 7 is a partially cutaway front view showing a schematic configuration of a single-staged rocket on which control devices according to a third embodiment and fourth embodiment of the present disclosure are mounted. A single-staged rocket 3 of this embodiment, which is shown in FIG. 7, includes a fuel tank 31a of liquid oxygen and liquid hydrogen, for example, and a rocket engine 31b that uses those propellants. Note that illustration of a solid rocket booster and an auxiliary engine, which are for use at a time of launching the single-staged rocket 3, in some case, is omitted.

When the rocket engine 31b is cut-off by fining use of the fuel (liquid oxygen and liquid hydrogen, in this case) of the fuel tank 31a, the single-staged rocket 3 drops and is discarded before long. Ignition and cut-off of the rocket engine 31b are controlled by a mounted computer 33c (corresponding to a control device for a rocket in the claims) of the single-staged rocket 3.

To the mounted computer 33c, an IMU 33d is connected, which senses a flight speed, flight position and flight attitude of the single-staged rocket 3 by using gyro and acceleration sensors. The mounted computer 33c controls a propelling direction and the like of the rocket engine 31b based on the flight speed, the flight position and the flight attitude, which are calculated by the IMU 33d, so that the single-staged rocket 3 can fly through a nominal flight path of which data is stored in an internal memory of the mounted computer 33c.

Moreover, the mounted computer 33c monitors an amount of the fuel remaining in the fuel tank 31a of the single-staged rocket 3, and predicts a flight path of the single-staged rocket 3 based on the monitored amount of fuel and on the flight speed, flight position and flight attitude of the single-staged rocket 3, which are sensed by the IMU 33d.

The flight path predicted by the mounted computer 33c (that is, a predicted flight path) includes a path along which the single-staged rocket 3 flies from now on by propelling power of the rocket engine 31b by using residual fuel of the fuel tank 31a until the rocket engine 31b is cut-off.

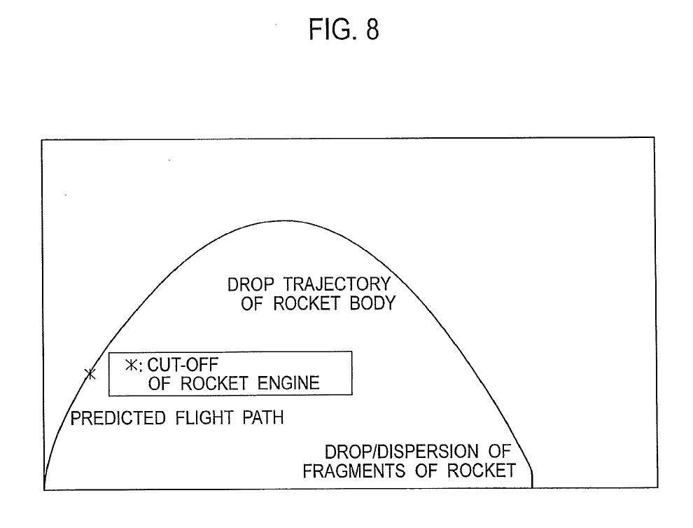

Note that, in a solid line in an explanatory view of FIG. 8, a segment from a launching point in which both of a ground surface distance and an altitude are “0” to a cut-off point of the rocket engine 33b, which is indicated by a plot point as an asterisk in FIG. 8, is the predicted flight path of the single-staged rocket 3, which is predicted by the mounted computer 33c.

Then, the mounted computer 33c calculates a point where the single-staged rocket 3 is estimated to impact in a case where the rocket engine 31b of the single-staged rocket 3 is cut-off at an engine cut-off point on the predicted flight path, that is, estimates the instantaneous impact point (IIP). Note that the mounted computer 33c calculates the estimated impact point of the single-staged rocket 3 based on the flight speed, flight position and flight attitude of the single-stage rocket 3 on the predicted flight path.

Moreover, the estimated impact point of the single-staged rocket 3 is varied depending on to which point on the predicted flight path the cut-off point of the first-stage rocket engine 31b is to be decided. Accordingly, the mounted computer 33c sets a plurality of scheduled passing points on the predicted flight path, and individually calculates the estimated impact points of the single-staged rocket 3 for cases where the respective scheduled passing points are decided to be the cut-off point of the rocket engine 31b.

Incidentally, the predicted flight paths of the single-staged rocket 3, which is predicted by the mounted computer 33c, is a so-called nominal flight path. However, in an actual flight path of the single-staged rocket 3, dispersions for the nominal flight path occurs by an influence of dispersions in mass properties, engine performances, weather condition or the like. Then, this dispersion is not reflected on the predicted flight path of the single-staged rocket 3, which serves as a base in an event where the mounted computer 33c calculates the estimated impact points of the single-staged rocket 3.

Accordingly, in consideration of the dispersion of the actual flight path of the single-staged rocket 3 with respect to the nominal flight path, the mounted computer 33c calculates the estimated impact point of the single-staged rocket 3 as a range considering some dispersions.

Note that, in an internal memory of the mounted computer 33c, topographic data that defines a safe area where the drop of the single-staged rocket 3 is allowed is stored together with data of the nominal flight path of the single-staged rocket 3. The stored topographical data is substantially like that shown in the explanatory view of FIG. 3.

Moreover, in the internal memory of the mounted computer 33c, data indicating a fragment impact area of the dropped single-staged rocket 3 is stored. A size and shape of this fragment impact area differ depending on a launch capability of the single-staged rocket 3.

Then, the mounted computer 33c collates such estimated impact points of the single-staged rocket 3 (which include the fragment impact area) with the topographic data, and extracts the estimated impact point of the single-staged rocket 3, which is placed within the safe area SA. Moreover, the mounted computer 33c defines a scheduled passing point, which corresponds to the extracted estimated impact point and is assumed to be the cut-off point of the rocket engine 31b on the predicted flight path of the single-staged rocket 3, as an official cut-off point of the rocket engine 31b.

At this time, in a case where there are a plurality of the estimated impact points of the single-staged rocket 3, which include the fragment impact area and are located within the safe area SA, the mounted computer 33c defines a scheduled passing point, which is safe and nearest to ILL of the single-staged rocket 3 among a plurality of such scheduled passing points, as the official cut-off point of the rocket engine 31b.

In such a way, until the rocket engine 31b of the single-staged rocket 3 is cut-off, the single-staged rocket 3 will fly much farther by the propelling power of the rocket engine 31b. Therefore, the launch capability of the single-staged rocket 3 can be enhanced.

Note that the mounted computer 33c periodically and repeatedly calculates the predicted flight path and estimated impact point of the single-staged rocket 3 the predicted flight path and the estimated impact point being shown in FIG. 8. In such a way, even if a consumption pace of the fuel by the single-staged rocket 3 fluctuates during the flight due to a dispersions in mass properties, engine performances, change of the weather condition, and the like, the predicted flight path and the estimated impact point, which are predicted by the mounted computer 33c, can be updated in response to such a fluctuation at any time.

Then, when the single-staged rocket 3 reaches the cut-off point of the rocket engine 31b (when the flight position of the single-staged rocket 3 coincides therewith), the mounted computer 33c cuts-off the rocket engine 31b.

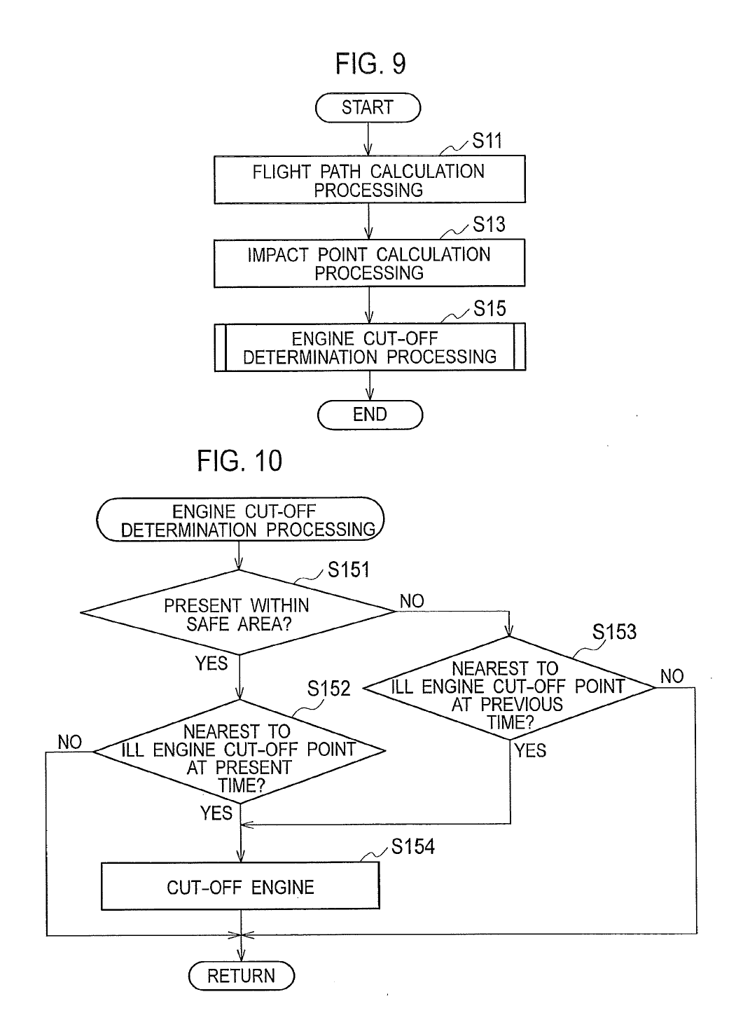

Next, referring to a flowchart of FIG. 9, a description is made of processing regarding the cut-off of the rocket engine 31b, which is performed by the above-mentioned mounted computer 33c during the flight of the single-staged rocket 3.

In order to cut-off of the rocket engine 31b so that the single-staged rocket 3 can drop to impact within the safe area SA, the mounted computer 33c of this embodiment executes flight path prediction processing (Step S11), impact point prediction processing (Step S13), and engine cut-off determination processing (Step S15), which are shown in FIG. 9, periodically and repeatedly during the flight of the single-staged rocket 3.

Then, in the flight path calculation processing of Step S11, the mounted computer 33c calculates the predicted flight path of the single-stage rocket 3 before the combustion of the rocket engine 31b is cut-off.

Note that the mounted computer 33c calculates the predicted flight path of the single-staged rocket 3 based on the amount of the fuel remaining in the fuel tank 31a and based on the flight schedule (speed, position and attitude) of the single-staged rocket 3 before the rocket engine 31b is cut-off, the flight speed, the flight position and the flight attitude being calculated by the IMU 33d.

Next, in the impact point estimation processing of Step S13, the mounted computer 33c estimates the impact point (estimated impact point) of the single-staged rocket 3. Here, the mounted computer 33c estimates the impact point (estimated impact point) of the single-staged rocket 3 based on the cut-off point of the rocket engine 31b, which is assumed on the predicted flight path of the single-staged rocket 3.

Subsequently, in the engine cut-off determination processing of Step S15, as shown in a flowchart of FIG. 10, the mounted computer 33c confirms an impact point, which is placed within the safe area SA, among such impact points (estimated impact points) of the single-staged rocket 3, which are calculated in the impact point estimation processing of Step S13 in the present cycle (Step S151).

In a case where there is an impact point of the single-staged rocket 3, which is placed within the safe area SA (YES in Step S151), the mounted computer 33c determines whether or not the single-staged rocket 3 has reached the cut-off point, which is safe and nearest to ILL point of the single-staged rocket 3 among the combustion cut-off points of the rocket engine 31b, which correspond to the predicted drop point of the single-staged rocket 3, the estimated impact points being predicted in Step S13 of FIG. 9 in the present cycle (Step S152).

Then, in the case of having determined that the single-staged rocket 3 has reached the point which is safe and nearest to ILL of the single-staged rocket 3 (YES in Step S152 or Step S153), then the mounted computer 33c cuts-off the rocket engine 31b (Step S154), and ends the engine cut-off processing.

As obvious also from the above description, in this embodiment, Step S11 in the flowchart of FIG. 9 is such processing corresponding to the flight path calculation processor in the claims. Moreover, in this embodiment, Step S13 in FIG. 9 is processing corresponding to the impact point estimation processor in the claims. Furthermore, in this embodiment, Step S15 in FIG. 9 is processing corresponding to the engine cut-off control processor in the claims.

As described above, in the single-staged rocket 3 of this embodiment, the flight path of the single-staged rocket 3 is periodically calculated during the flight, and the estimated impact point of the single-staged rocket 3 in the case where the rocket engine 31b is cut-off at each scheduled passing point on the predicted flight path is calculated periodically.

Then, while the scheduled passing point in which the estimated impact point of the single-staged rocket 3 is placed within the safe area SA is present, the processing for defining the safe and nearest to ILL scheduled passing point of the single-staged rocket 3 as the cut-off point of the rocket engine 31b is periodically performed.

Therefore, the cut-off point of the rocket engine 31b is updated to the safe and nearest to ILL scheduled passing point of the single-staged rocket 3 at any time. Hence, while extending the acceleration by consuming the fuel in the fuel tank 31a as much as possible to thereby enhance the launch capability of the single-staged rocket 3, the single-staged rocket 3 can be impact to the safe area SA.

Next, a description is made of a control device according to a fourth embodiment of the present disclosure, which is mounted on the single-staged rocket 3.

Also in this embodiment, the mounted computer 33c calculates the flight path of the single-staged rocket 3 periodically during the flight, and periodically calculates the estimated impact point of the single-staged rocket 3 in the case where the rocket engine 31b is cut-off at each scheduled passing point on the predicted flight path.

Then, in this embodiment, the mounted computer 33c estimates whether or not none of such estimated impact points of the single-staged rocket 3, which are calculated in a next period, comes to be located within the safe area SA of the topographic data. The mounted computer 33c performs this estimation based on a change of at least one of the predicted flight path of the single-staged rocket 3 and the estimated impact point of the single-staged rocket 3, the change being observed between two immediately previous cycles which continue with each other.

Specifically, for example, the mounted computer 33c adds a variation obtained from the estimated impact point of the single-staged rocket 3, which is calculated in the previous cycle, to the estimated impact point of the single-staged rocket 3, which is calculated in the present cycle, and thereby calculates the estimated impact point of the single-staged rocket 3, which is calculated in the nest cycle. Then, the mounted computer 33c determines whether or not the predicted impact point of the single-staged rocket 3 in the next cycle, the estimated impact point being thus calculated, is placed within the safe area SA.

Alternatively, for example, the mounted computer 33c adds a variation obtained from the cut-off point of the rocket engine 31b, which is predicted in the previous cycle, to the combustion cut-off point of the rocket engine 31b, which is calculated in the present cycle, and thereby calculates the cut-off point of the rocket engine 31b, which is predicted in the next cycle.

Then, the mounted computer 33c determines whether or not the estimated impact point of the single-staged rocket 3 in the next cycle, the estimated impact point being thus estimated, is placed within the safe area SA.

If the estimated impact point of the single-staged rocket 3 is placed within the safe area SA, then there is obtained such an calculation result that the estimated impact point of the single-staged rocket 3, which is calculated in the next cycle, is located within the safe area SA of the topographical data.

Then, in such a case of having calculated that none of such estimated impact points of the single-staged rocket 3, which are predicted calculated in the next cycle, comes to be located within the safe area SA of the topographical data, the mounted computer 33e decides the combustion cut-off point of the rocket engine 31b.

Specifically, the mounted computer 33c extracts the estimated impact point of the single-staged rocket 3, which is placed within the safe area SA, among such estimated impact points of the single-staged rocket 3, which are calculated in the present cycle. Then, the mounted computer 33c defines the scheduled passing point safe and nearest to ILL of the single-staged rocket 3 among the scheduled passing points corresponding to the estimated impact point, which is thus extracted, as the cut-off point of the rocket engine 31b.

Then, when the single-staged rocket 3 reaches the cut-off point of the rocket engine 31b (when the flight position of the single-staged rocket 3 coincides therewith), the mounted computer 33c cuts-off the rocket engine 31b.

Therefore, also in this embodiment, in order to cut-off the combustion of the rocket engine 31b so that the single-staged rocket 3 can drop to impact within the safe area SA, the mounted computer 33c performs the flight path calculation processing (Step S11), the impact point estimation processing (Step S13), and the engine cut-off determination processing (Step S15), which are shown in FIG. 9, periodically and repeatedly during the flight of the single-staged rocket 3.

Then, in the flight path calculation processing of Step S11 and the impact point estimation processing of Step S13, the mounted computer 33c performs similar processing to that of the third embodiment. Meanwhile, in the engine cut-off determination processing of Step S15, the mounted computer 33c performs different processing from that of the third embodiment.

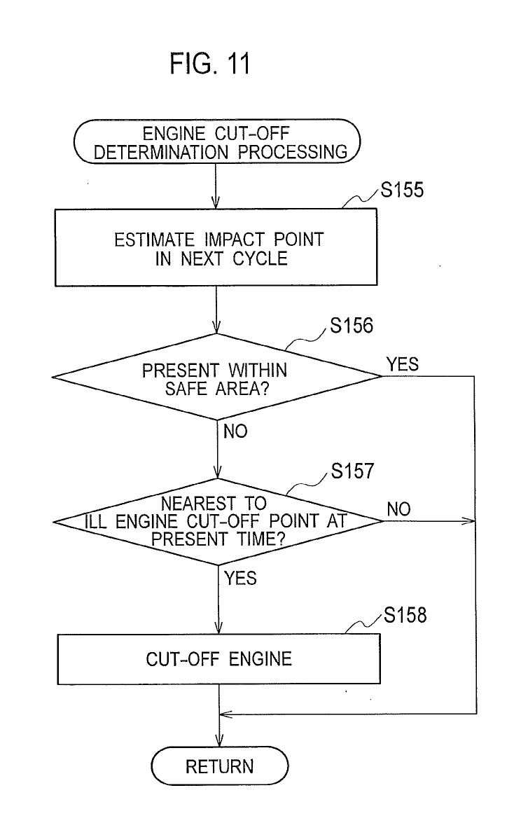

Specifically, first, as shown in a flowchart of FIG. 11, the mounted computer 33c calculates the estimated impact points of the single-staged rocket 3, which are calculated in the next cycle (Step S155), and confirms whether or not there is a estimated impact point of the single-staged rocket 3, which is located within the safe area SA of the topographical data, among the estimated impact points of the single-staged rocket 3, which are thus calculated (Step S156).

In a case where there is a estimated impact point, which is located within the safe area SA of the topographic data, among the estimated impact points of the single-staged rocket 3, which are thus estimated (YES in Step S156), the mounted computer 33c ends the cut-off determination processing.

Then, in the case of having determined that the single-stage rocket 3 has reached the nearest cut-off point to ILL of the single-staged rocket 3 (YES in Step S15), then the mounted computer 33c cuts-off the rocket engine 31b (Step S158), and ends the engine cut-off determination processing.

Also in the above-mentioned embodiment, Step S11 in the flowchart of FIG. 9 is such processing corresponding to the flight path calculation processor in the claims. Moreover, also in this embodiment, Step S13 in FIG. 9 is processing corresponding to the impact point estimation processor in the claims. Furthermore, also in this embodiment, Step S15 in FIG. 9 is processing corresponding to the engine cut-off controller in the claims.

Then, in the single-staged rocket 3 of this embodiment, the flight path of the single-staged rocket 3 is periodically calculated during the flight, and the estimated impact point of the single-staged rocket 3 in the case where the rocket engine 31b is cut-off at each scheduled passing point on the predicted flight path is calculated periodically.

Moreover, from the changes of the predicted flight path and the estimated impact point between two continuous cycles, the estimated impact points of the single-staged rocket 3, which are calculated in the next cycle, are individually estimated.

Then, while the estimated impact point located within the safe area SA is present among the estimated impact points of the single-staged rocket 3, which are thus calculated, the combustion cut-off point of the rocket engine 31b is not decided, but the processing for calculating the predicted flight path and the estimated impact point is also calculated in the next cycle.

Therefore, until the estimated impact point located within the safe area SA comes not to be present among the estimated impact points of the single-staged rocket 3, which are thus estimated, the combustion cut-off point of the rocket engine 31b is updated to the nearest to ILL scheduled passing point of the single-staged rocket 3 at any time.

Hence, while extending the acceleration by consuming the fuel in the fuel tank 31a of the single-staged rocket 3 as much as possible to thereby enhance the launch capability of the single-staged rocket 3, the single-staged rocket 3 can be dropped to impact within the safe area SA.

What is claimed is:

1. A control device for a rocket, cutting-off a rocket engine during flight of the rocket and discarding a discarded object, the control device comprising:
a flight path calculating processor that periodically calculates a predicted flight path, the rocket flies therealong from now on by residual fuel, based on a flight schedule (speed, position and attitude) of the rocket;
a impact point estimation processor that periodically predicts calculates estimated impact points of the discarded object in a case of cutting-off the rocket engine at respective scheduled passing points on the predicted flight path of the rocket; and
an engine cut-off controller that cuts-off the rocket engine and discards the discarded object in a case where the flight position of the rocket coincides with a scheduled passing point nearest to ILL of the rocket, the scheduled passing point also being where the discarded object discarded at a scheduled passing point is expected to drop to impact within a safe area on predetermined topographic data, the scheduled passing point being among respective scheduled passing points on a predicted flight path calculated in a past cycle.

2. A control device for a rocket, cutting-off a rocket engine during flight of the rocket and dropping a discarded item object, the control device comprising:
a flight path calculating processor that periodically calculates a predicted flight path, the rocket flies therealong from now on by residual fuel, based on a flight schedule (speed, position and attitude) of the rocket;
a impact point estimating processor that periodically calculates estimated impact points of the discarded item in a case of cutting-off the rocket engine at respective scheduled passing points on the predicted flight path of the rocket; and
an engine cut-off controller, in a case where it is estimated that none of estimated impact points of the discarded object, predicted for respective scheduled passing points on a predicted flight path calculated in a next cycle from a change of at least one of the predicted flight path of the rocket and the estimated impact point of the discarded object between two immediately previous cycles continuing with each other, comes to be located within a safe area on predetermined topographic data, for cutting-off the rocket engine and dropping the discarded object at a farthest scheduled passing point safe and nearest to ILL of the rocket, the scheduled passing point being where a estimated impact point of the discarded object is located within the safe area on the topographic data, the scheduled passing point being among respective scheduled passing points on a predicted flight path calculated at a present time, and the estimated impact point being calculated to correspond to each of the scheduled passing points.

3. The control device for a rocket according to claim 1, wherein the rocket is a multi-staged rocket, the discarded object includes at least an (n−1)-th-stage rocket separated and discarded from an n-th-stage rocket, the flight path calculating processor periodically calculates a predicted flight path, the multi-staged rocket flies therealong from now on by propelling power generated by an (n−1)-th-stage rocket engine by using residual fuel, based on a flight schedule (speed, position and attitude) of the multi-staged rocket, and for respective scheduled passing points on the predicted flight path of the multi-stage rocket, the impact point estimating processor periodically calculates estimated impact points of the (n−1)-th-stage rocket in a case where the (n−1)-th-stage rocket engine is cut-off and the (n−1)-th-stage rocket is separated and discarded from the n-th-stage rocket.

4. The control device for a rocket according to claim 2, wherein the rocket is a multi-staged rocket, the discarded object includes at least an (n−1)-th-stage rocket body separated and discarded from an n-th-stage rocket, the flight path calculating processor periodically calculates a predicted flight path, the multi-staged rocket flies therealong from now on by propelling power generated by an (n−1)-th-stage rocket engine by using residual fuel, based on a flight schedule (speed, position and attitude) of the multi-staged rocket, and for respective scheduled passing points on the predicted flight path of the multi-staged rocket, the impact point estimating processor periodically calculates estimated impact points of the (n−1)-th-stage rocket in a case where the (n−1)-th-stage rocket engine is cut-off and the (n−1)-th-stage rocket body is separated and discarded from the n-th-stage rocket.
